(19) United States
(12) Patent Application Publication
(10) Pub. No.: US 2004/0203487 A1
(43) Pub. Date: Oct. 14, 2004

(54) Antenna integrated into chassis of portable device

(76) Inventor: David A. Kaysen, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/222,165

(22) Filed: Aug. 16, 2002

(51) Int. Cl. H04B 1/38

(52) U.S. Cl. 455/90.1; 455/347

(57) ABSTRACT

A chassis having an interior surface, the interior surface having a first area coated with a metal substance to receive a radio signal. At least a first metal tab coupled to the first area coated with a metal substance, and the first metal tab coupled to a circuit board, the first metal tab to transmit a signal between the first area of the chassis coated with a metal substance and the circuit board.

### BACKGROUND

There exists a continuous need in the field of portable computers and personal digital assistants (PDAs) to improve the ability to send and receive data remotely via wireless techniques. There exists today several techniques for portable computers and PDAs to send and receive data, but most of the techniques seem to have short comings.

Such techniques include plugging a modem of a portable computer into a phone jack, or inserting a wireless modem into a portable computer. With PDAs, there are special designed attachable wireless modems that can be attached to the PDAs to provide wireless communication.

Each of the current solutions for providing wireless communications have shortcomings. For example, the solutions may be bulky, costly, and may involve significant user interaction/operation to have the portable device operable for wireless communication.

Therefore what is needed is an improved technique for providing portable devices with wireless communication that cost less, is less bulky, and requires less interaction on behalf of a user to support wireless communication.

### BRIEF DESCRIPTION OF THE DRAWINGS

FIG. 1 is an illustration of a chassis having an area of the chassis coated with metal to provide wireless transmission, according to one embodiment.

FIG. 2 is an illustration of a chassis having a metal strip applied to the interior area of the chassis via adhesive to provide wireless transmission, according to one embodiment.

### DETAILED DESCRIPTION

The present application describes an antenna integrated into the chassis of a portable device. In the following description, for purposes of explanation, numerous specific details are set forth in order to provide a thorough understanding of the invention. It will be apparent however, to one skilled in the art that the invention can be practiced without these specific details. In other instances, structures and devices are shown in block diagram form in order to avoid obscuring the invention. Reference in the specification to “one embodiment” or “an embodiment” means that a particular feature, structure, or characteristic described in connection with the embodiment is included in at least one embodiment of the invention. The appearances of the phrase “in an embodiment” in various places in the specification are not necessarily all referring to the same embodiment.

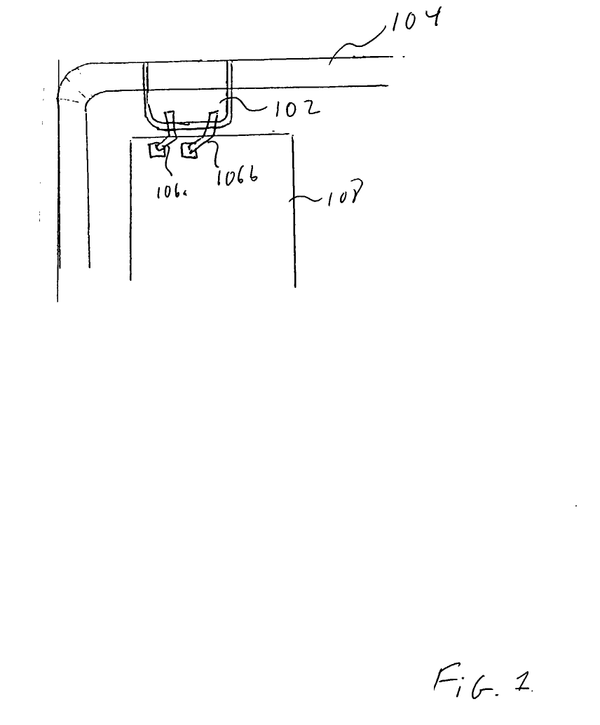

FIG. 1 illustrates one embodiment of antenna integrated into the chassis 104 of a portable device. In particular, as shown in FIG. 1, an interior surface of the chassis is coated with a metal substance 102. The metal substance 102 is configured to receive or transmit radio signals. The actual metal substance used may vary based on implementation choice, but may be selected from metals such as aluminum, copper, or other aluminum based alloys or other transitional metals. In addition, the configuration of the metal substance 102 as coated on the interior surface of the chassis 104 is also a choice of implementation that may vary based on the type of radio signal intended to be communicated and/or received.

As further illustrated in FIG. 1, the antenna integrated into the chassis of a portable device is coupled to a circuit board by two tabs 106a, 106b. A first tab 106a is provided to communicate signals between the antenna and the circuit board 108. A second tab 106b is provided to provide a ground between the antenna and the circuit board 108.

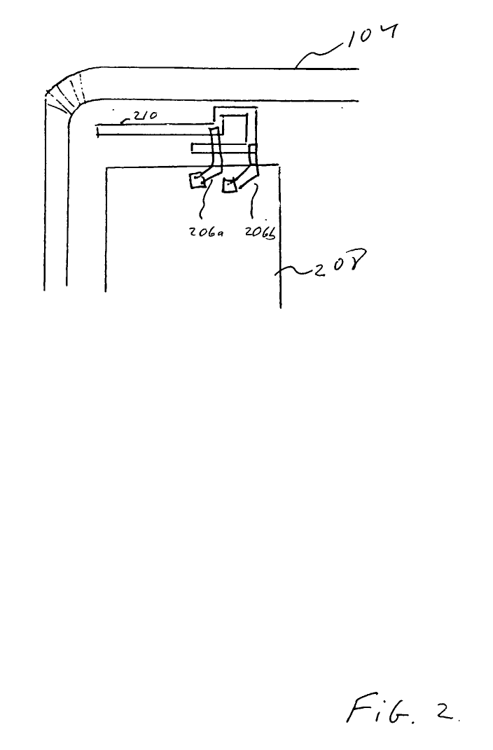

FIG. 2 illustrates an alternative embodiment of an antenna integrated into the chassis 104 of a portable device. In particular, as shown in FIG. 2, a metal strip 210 is applied to an interior surface of the chassis 104. The metal strip 210 is configured to receive or transmit radio signals. The actual metal strips used may vary based on implementation choice, but may be selected from metals such as aluminum, copper, or other aluminum based alloys or other transitional metals. In addition, the configuration of the metal strip integrated on the interior surface of the chassis is also a choice of implementation that may vary based on the type of radio signal intended to be communicated and/or received.

The metal strip, as illustrated in FIG. 2, is attached to the chassis via an adhesive. For example, in one embodiment, the metal strip may be attached to the chassis via a poxy silicon material. In alternative embodiments, alternative adhesives may be used without departing from the scope of the invention.

As further illustrated in FIG. 2, the antenna integrated into the chassis of a portable device is coupled to a circuit board by two tabs 206a, 206b. A first tab 206a is provided to communicate signals between the antenna and the circuit board 208. A second tab 206b is provided to provide a ground between the antenna and the circuit board 208.

In one embodiment, the antenna integrated into the chassis of the portable device as illustrated and described in FIGS. 1 and 2 is configured to transmit radio signals in accordance with the bluetooth wireless specification. In one embodiment, the bluetooth wireless specification includes transmitting wireless signals in the unlicensed, 2.4 GHz radio spectrum. The radios use a spread spectrum, frequency hopping, full-duplex signal at up to 1600 hops/sec. The signal hops among 79 frequencies at 1 MHz intervals to give a high degree of interference immunity.

In one embodiment, the chassis, including the integrated antenna as described above, may be designed for a personal digital assistant (PDA). For example, the PDA may include a handheld computer that serves as an organizer for personal information. The PDA may include a name and address database, to-do list and note taker. Some PDAs are pen based and use a stylus to tap selections on menus and to enter printed characters. The unit may also include a small on-screen keyboard which is tapped with the pen. In one embodiment, data is synchronized between the PDA and a desktop computer via cable or wireless transmission.

In an alternative embodiment, the chassis, including the integrated antenna as described above, may be designed for a portable computer, such as a laptop computer. In one embodiment, the area of the chassis coated with the metal substance 102 or having the metal strips 210, includes an interior surface area of a lid of a portable computer, the lid housing a display.

Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

1. A apparatus comprising:
Chassis of portable computing device having an interior surface, the interior surface having a first area coated with a metal substance to receive a radio signal; and
At least a first metal tab coupled to the first area coated with a metal substance, and the first metal tab coupled to a circuit board, the first metal tab to transmit a signal between the first area of the chassis coated with a metal substance and the circuit board.

2. The apparatus of claim 1, wherein the apparatus includes a second metal tab coupled between the circuit board and the first area of the chassis coated with a metal substance, the second metal tab to provide a ground between the circuit board and the first area of the chassis coated with a metal substance.

3. The apparatus of claim 2, wherein the metal substance comprises an aluminum based alloy.

4. The apparatus of claim 2, wherein the apparatus is a personal digital assistant.

5. The apparatus of claim 2, wherein the apparatus is a portable computer.

6. The apparatus of claim 2, wherein the radio signal is a bluetooth signal.

7. The apparatus of claim 5, wherein the first area of the chassis coated with the metal substance includes an interior surface area of a lid of the portable computer, the lid housing a display.

8. The apparatus of claim 2, wherein the metal substance comprises an a copper metal.

9. A apparatus comprising:
chassis of portable computing device having an interior surface, the interior surface having a metal strip attached to the interior surface, the metal strip to receive a radio signal; and
at least a first metal tab coupled to the metal strip, and the first metal tab coupled to a circuit board, the first metal tab to transmit a signal between the metal strip and the circuit board.

10. The apparatus of claim 9, wherein the apparatus includes a second metal tab coupled between the circuit board and the metal strip attached to the interior surface of the chassis, the second metal tab to provide a ground between the circuit board and the metal strip attached to the interior surface of the chassis.

11. The apparatus of claim 9, wherein the metal strip comprises an aluminum based alloy.

12. The apparatus of claim 9, wherein the apparatus is a personal digital assistant.

13. The apparatus of claim 9, wherein the apparatus is a portable computer.

14. The apparatus of claim 9, wherein the radio signal is a bluetooth signal.

15. The apparatus of claim 9, wherein the metal strip is attached to an interior surface area of a lid of the portable computer, the lid housing a display.

16. The apparatus of claim 2, wherein the metal strip comprises an a copper metal.

17. A personal digital assistant comprising:
Chassis having an interior surface, the interior surface having a first area coated with a metal substance to receive a radio signal, wherein the metal includes an aluminum based alloy;
a first metal tab coupled to the first area coated with a metal substance, and the first metal tab coupled to a circuit board, the first metal tab to transmit a signal between the first area of the chassis coated with a metal substance and the circuit board; and
a second metal tab coupled between the circuit board and the first area of the chassis coated with a metal substance, the second metal tab to provide a ground between the circuit board and the first area of the chassis coated with a metal substance.

18. The personal digital assistant of claim 17, wherein the radio signal is a bluetooth signal.
